(19) United States
(12) Patent Application Publication
(10) Pub. No.: US 2022/0055938 A1
(43) Pub. Date: Feb. 24, 2022

(54) DEVICE FOR HOLDING A GLASS PREFORM

(71) Applicant: FÜLLER GLASTECHNOLOGIE VERTRIEBS-GmbH, Spiegelau (DE)

(72) Inventor: Bernhard ALTENDORFER, Waldkirchen (DE)

(21) Appl. No.: 17/309,833

(22) PCT Filed: Dec. 19, 2019
(86) PCT No.: PCT/EP2019/086313

§ 371 Date: Jun. 22, 2021

(30) Foreign Application Priority Data
Dec. 28, 2018 (DE) 10 2018 133 667.5
Jul. 2, 2019 (DE) 10 2019 117 756.1

(51) Int. Cl. C03B 35/00; C03B 35/04; C03B 23/00

(52) U.S. Cl. CPC C03B 35/005; C03B 23/0013; C03B 35/04

(57) ABSTRACT

The invention relates to a device for supportingly holding, and moving, a glass preform, such as a gob, wherein the device has a carrier device, at least one rod-shaped support element, which during operation is substantially vertically aligned, wherein, at its upper end, the rod-shaped support element opens into at least one point-shaped upwardly directed support surface; and/or the device has at least one support element which during operation is substantially vertically aligned, has a substantially inverted U-shape, and has a support surface which is upwardly directed and connects the substantially vertically extending vertical portions of the support element.

The invention relates to a device for holding, in particular supportingly holding, and optionally moving, in particular moving, a glass article according to the preamble of patent claim 1.

Such devices are usually used to handle glass preforms, such as gobs, in order to move them, for example, from one place to another place and/or, if appropriate, to heat them in a furnace. For the latter, the aforementioned devices are used, for example, to move a glass preform, usually from below, into a furnace, to at least superficially soften or melt it there and then to deliver it to a pressing or blanking operation.

Such devices are known, for example, from the publications DE 101 16 139 B4, DE 101 00 515 B4 or DE 101 65 031 B4, which for supportingly holding use an at least largely closed annular support surface or two approximately semi-annular support surfaces on which the gob rests to support it.

A significant disadvantage of the devices for supportingly holding a gob known from these publications is that the support of these devices, on which the gob rests, due to their annular or semi-annular geometry, result in a very large-area support for the gob, which results in a very large area of the gob, namely the entire contact area of the gob with the respective support surface, being shielded or shaded during thermal treatment of the gob, which results in that a homogeneous temperature control of the gob, in particular homogeneous heating or cooling of the entire surface of the gob, is practically impossible and in the area of the contact surface of the gob undesirable temperature gradients inevitably arise. The latter is all the more problematic with the aforementioned devices because the temperatures required to soften or superficially melt the glass preform are in the range of several hundred degrees Celsius, for example in the range of 700° C. and higher, which generally requires the use of a high-temperature-stable metallic support surface which, however, in turn has a high thermal conductivity due to its metal character, which in turn favours the formation of a temperature gradient in the area of the contact surface of the gob.

Another disadvantage of the above-mentioned devices for supporting a gob is, among other things, the annular or semi-annular geometry of these devices, since this geometry requires very precise manufacture and the use of very temperature-stable materials, or metals, in order to avoid distortions of the support surface of the respective device in the course of thermal treatment, which would have an extremely detrimental effect on the thermal treatment of the glass preform due to a non-uniform and uneven contact surface and thus surface load. According to the state of the art, this problem is countered by designing the holding device as a pipe system through which a cooling medium, such as air, flows. This means, however, that the manufacture of such prior art devices for supportingly holding a glass preform is not only very complex, but concomitant with that also expensive.

A further disadvantage of such known devices is furthermore the predetermined annular or semi-annular geometry of their support surface, which is only designed for a specific type and a specific size of glass preform and, due to the principle, is practically not adaptable to possible other shapes and/or sizes of glass preforms.

The invention is based on the object of providing a device for supportingly holding a glass preform, such as for example a gob, which avoids the aforementioned disadvantages of such devices known from the prior art, at the same time enabling simpler and more cost-effective manufacture and, moreover, being universally applicable.

This object is solved by a device according to patent claim 1.

In particular, this object is solved by a device for supportingly holding and, if necessary, moving a glass preform, such as for example a gob, in which the device comprises a carrier device with at least one rod-shaped support element which is substantially vertically aligned in operation, the rod-shaped support element terminating at its upper end in at least one point-shaped, upwardly directed support surface.

Furthermore, as an alternative or in addition to at least one rod-shaped support element, the device according to the invention may comprise at least one support element which, in operation, is substantially vertically oriented and substantially inverted-U-shaped, with an upwardly directed support surface and connecting the substantially vertically extending vertical portions of the support element.

An important point of the invention in this respect is that the device according to the invention for supportingly holding a glass preform uses support elements which have at their upper ends a substantially point-shaped and thus very small support surface on which the glass preform rests.

Thus, an important point of the invention is that the device according to the invention supports the glass preform with as little contact as possible, i.e. provides a support surface for the glass preform which has the smallest possible contact surface with the glass preform, so that, during a thermal treatment of the glass preform, the smallest possible shadowing and in no case a large-area shielding of surfaces of the glass preform is ensured, so that the entire surface of the glass preform can be heated and cooled as homogeneously and uniformly as possible.

Here it is important to understand that in the context of the invention the term “point-shaped” is of course not to be understood mathematically, but rather expresses according to the invention that the support surface formed on each support element by no means forms a large-area support surface known from the prior art, but is designed to be as small as possible.

Thus, the respective point-shaped support surfaces according to the invention each have an area in the range of 1 mm² to 100 mm², preferably 12 mm² to 60 mm² and particularly preferably 20 mm² to 40 mm². By maintaining these dimensions, it is ensured in accordance with the invention that the support elements used in accordance with the invention, or the support surfaces arranged at their respective upper ends, have only a very slight and, in the best case according to the invention, no thermal influence at all, or a thermally negligible influence, on the glass preform in the course of a thermal treatment of the glass preforms resting on the support elements. In this way, the area shaded by the contact surface of the gob can be reduced by a factor of 3 to 5 compared to possibilities known from the prior art. This means that in the case of a gob, due to the very large support surface according to the prior art, where up to now a third to a quarter of the contact surface has been shaded by the annular or semi-annular geometry of previous support devices, according to the invention significantly less, i.e. only about 10% to 30% of the surface of the gob shadowed in the prior art is shadowed.

This inventively very advantageous effect is essentially due to the fact that, according to the invention, an annular or semi-annular support surface as in the prior art is not used for the glass preform, but an substantially point-shaped support surface is used, whereby, when calculating the respective support surface of the glass preform, or the surface of the glass preform shaded due to the support on the support elements, it is already taken into account that the glass preform generally does not rest on a single support element, but on at least two or more support elements, so that a respective glass preform rests in any case securely and without wobbling on preferably three support points. These support points can be in the form of three point-shaped upwardly directed support surfaces or can consist of a combination of an inverted U-shaped support element with a further such inverted U-shaped support element, each with very narrow line-shaped contact surfaces, or one or more rod-shaped support elements, each with a point-shaped support surface. A respective combination of support elements, i.e. whether rod-shaped or inverted U-shaped, is determined by the respective requirements; the same also applies to the number of support elements to be used in each case, whereby both the type and the number of the respective support elements are essentially based on the geometry and/or size of a respective glass preform.

Thus, by means of the device according to the invention, it is possible, on the one hand, to significantly reduce the contact surface of a respective glass preform on respective support elements compared to the state of the art, which at the same time, in an inventively extremely advantageous manner, also contributes to the fact that the shadowing area caused on the glass preform by the support elements in the course of a heat treatment of the glass preform is significantly reduced, namely to the aforementioned dimension. This reduced shadowing of a respective glass preform to be heated is accompanied by substantial advantages when heating the gob in a furnace, which in turn is significantly reflected in the quality of the finished glass article.

According to a preferred embodiment, the at least one, in particular rod-shaped, support element according to the invention has at least two, in particular fork-shaped, projections at its upper end, each of which terminates in a point-shaped, upwardly directed support surface. For this purpose, the support element of the device according to the invention has a central foot which supports the support element, from which, possibly via a rod-shaped or tubular intermediate section, individual extensions extend upwards in the shape of a fork in the direction of the support surfaces. The individual extensions can branch off from a single branching point or at different heights and on different sides of the rod-shaped or tubular intermediate section. Furthermore, according to the invention, it is possible for individual extensions to branch again once or several times, where each of these individual extensions ends in an essentially point-shaped support surface.

Furthermore, the at least one support element may be substantially Y-shaped or formed with an inverted, i.e. upwardly pointing, at least tripod, wherein, in particular, each of the extensions respectively terminates in a point-shaped, upwardly pointing support surface. Instead of a substantially Y-shaped design of the support elements, they can also be substantially T-shaped, in which case the transverse beam of the T is concavely curved such that the respective ends of the transverse beam extend upwards with respect to the foot of the T and away from the foot, each in turn forming a support surface. In this way, a line-shaped support of a gob on the transverse beam, as it is known from the prior art, is reliably avoided, whereby an undesirable shadowing, as in the prior art, is advantageously omitted according to the invention.

According to a further embodiment of the invention, the device comprises at least two support elements according to the foregoing embodiments, wherein the respective support surfaces of the at least two support elements are preferably arranged or arrangeable in one plane. In this respect, it should be noted that the device according to the invention can also have three or more support elements, which can be mounted and adjusted, in particular height-adjustable, either together or individually.

All support elements are tubular and/or have cavities, such as for example a channel, through which a cooling medium can flow.

Furthermore, the support elements, or their extensions, as aforementioned, are designed in such a way that they are preferably arranged in a plane or can be arranged in such a plane, so that it is ensured that a gob rests securely and evenly supported in this plane on the respective point-shaped and/or line-shaped support surfaces of the support elements. In this context, it should be noted that the plane does not necessarily have to be planar, but can also be a curved plane that corresponds to a lower, i.e. on the support surfaces resting surface, or the shape of the gob.

In this context, it should also be pointed out that the device according to the invention has, if possible, only one, two or at maximum three support elements, which in combination of the support elements themselves have a number of support surfaces adapted to the respective gob to be held, so that the gob rests securely on these support surfaces and at the same time is shadowed as little as possible.

For this purpose, the support surfaces are each arranged at the vertices of a triangle, in particular an equilateral triangle, or, in the case of four or more support elements, of a polygon, in particular an equilateral polygon. In this way, it is ensured according to the invention that the glass preform is optimally supported and rests without wobbling on the support elements or support surfaces, and on the other hand that a uniformly thermally chargeable surface of the resting glass preform is available around each of the essentially point-shaped or line-shaped support surfaces, which can be heated or cooled in the course of a thermal treatment. Due to the fact that the respective support surfaces of the support elements for the glass preform are, on the one hand, very small and, and on the other hand, a homogeneous thermal treatment, such as heating, of the glass preform can take place around the support surfaces of the support elements, the area shielded by the actual contact surface of the glass preform with the support surface of the respective support element is very small and, according to the invention, practically negligible.

In this context, it should also be mentioned that the support elements are each height-adjustable either jointly or individually. For this purpose, the support elements can be attached either individually or jointly to a base body, which in turn can be moved vertically and/or horizontally. Furthermore, it should be pointed out in this context that individual support elements can also be replaced individually according to the invention. This is particularly advantageous when the gob geometry changes, so that a respective gob can individually, for example by means of extensions of different lengths, be supported and adapted to its respective geometry. The same applies to the use of rod-shaped support elements as well as to the use of inverted U-shaped support elements.

According to an alternative embodiment of the invention, the support elements can be controllable individually, for example with a servo motor, in particular a linear motor, so that each individual support element can be aligned and adjusted individually in terms of height. This is of particular advantage, for example, if the glass preform to be treated has an irregular geometry with which a uniform and, if desired, straight support on support elements set at identical heights would not be possible.

In this context, it should also be pointed out that a further possibility for providing support elements of different heights, which are for example arranged on a common base plate, is also possible in that the respective support elements can be provided with support surface pins of different lengths, as desired. According to the invention, the same also applies to individually height-adjustable support elements.

In the event that the support elements are arranged on a common base body, the support elements can be detachably fastenable to the base body by means of a quick-change fastener according to one embodiment of the invention. In this way, a simple and quick exchange of individual or all support elements is possible.

A further essential advantage of the device according to the invention is that due to the very small contact surface of the glass preform with the support surface of a respective support element, a heat dissipation, namely in the case of heating of the glass preform, is minimal or non-existent. The same applies analogously when heat is not to be supplied to the glass preform, but is to be extracted from it.

The support surfaces of the device according to the invention preferably have a symmetrical cross-section in top view and are preferably substantially round or annular, whereby the cross-section of the support surfaces can also be oval or angular, in particular rectangular, or of complex geometry, as desired and/or required. In this way, it is possible according to the invention to select a cross-section of the support surfaces which, taking into account the geometry of the glass preform, enables optimum thermal treatment of the glass preform and ensures that the glass preform is treated as homogeneously as possible. In the case of an inverted U-shaped support element, the cross-section of the respective support surfaces is straight line-shaped in top view.

According to an advantageous embodiment of the invention, the support surfaces of the device according to the invention are substantially flat or convexly curved at least in sections, in particular facing upwards. According to the invention, this applies both to point-shaped and to line-shaped support surfaces. By such a design of the support surfaces of the support elements on the one hand a uniform support of the glass preform on the respective support surface is ensured, whereby, in the case of a flat design of the support surface, a very uniform support of the glass preform is made possible over the entire contact surface of the glass preform with the support surface, which is essential, for example, if an imprint of the support surface on the heated glass preform is to be avoided, whereas a convexly curved support surface can be used if the actual contact surface of the glass preform with the support surface is to be reduced to a minimum. In the latter case, according to the invention, the support surface may also be needle-shaped pointed and/or pyramid-shaped, for example.

According to the invention, the support surfaces of the support elements of the device according to the invention are made of a high-temperature-resistant material, such as, for example, a refractory metal, for example steel, gold, copper, ruthenium, osmium, zirconium, hafnium, niobium, tantalum, chromium, molybdenum or tungsten, or a high-melting alloy or a ceramic, such as a carbide or nitride, which is inert to glass at temperatures in the range from 700° C. to 1500° C., in particular in the range from 700° C. to 1100° C. or in the range from 700° C. to 950° C., or coated, in particular coated, with such a high-temperature-resistant material. The use of high-temperature resistant stainless steel is particularly preferred here, especially for reasons of cost; however, the use of the other metals mentioned is also possible, whereby the selection of a respective metal can be made according to the respective requirements, which are based on the type of glass preform to be processed and its desired purpose.

According to a further advantageous embodiment of the invention, the support elements comprise at least one cavity and/or at least one channel and/or conduit, wherein the cavity and/or the channel and/or the conduit is/are able to be flowed-through with a fluid, in particular with a gaseous fluid, such as air. According to a preferred embodiment of the invention, a rod-shaped support element is, for example, hollow, wherein a fluid conduit through which a cooling fluid can flow is arranged in the hollow space of the rod-shaped support element. In the case of an inverted U-shaped design of a support element, the support element itself can be designed as a tube, in which case the cooling fluid flows through the tube itself. Due to the fact that in the latter case no separate fluid line has to be laid in the tube, an inverted U-shaped support element can thus be significantly thinner than a rod-shaped support element, which in turn contributes in an extremely advantageous manner according to the invention to significantly reduce the shadowing acting on the glass preform in the event of heating of the glass gob compared to the prior art.

Due to the provision of a cavity, a channel or a conduit in a respective support element according to the invention, cooling or warming/heating of the respective support elements is thus possible. On the one hand, this is advantageous in order to protect the support elements from overheating, but depending on the material and type of support element, it can also be used to heat and thus also thermally homogenise the surroundings of the support elements and the contact surface with the glass preform. In this respect, the cooling is controllable and can be adjusted such that for each support element a respective desired temperature can be achieved. A temperature regulation of the support elements can be, for example, realised by a respective flow rate of the cooling fluid, such as air. If required, the uppermost contact surface of a support element with the glass preform can be made of a particularly heat-resistant material, so that according to the invention, depending on the application, it is possible to dispense with cooling this uppermost contact surface of the support element with the glass preform, so that this uppermost contact surface does not necessarily have to be hollow, but can be.

Furthermore, the device according to the invention may comprise a reflector, preferably an IR radiation reflector, the reflecting surface of which is oriented in the direction of the support surfaces. In this way, a slightly increased temperature effect can be exerted on the glass preform in the area of the support surfaces due to the infrared radiation reflection, which counteracts any temperature dissipation by the support element. According to the invention, the reflection surface is arranged between a base body, to which the support elements are directly or indirectly attached, and the respective support surfaces and is aligned such that the heat radiation occurs in the direction of the shadowing by the support surfaces, in order to contribute to a temperature equalisation here, relative to the remaining, heated, or irradiated gob surface.

Furthermore, the device according to the invention can have at least one induction and/or IR heater, which is preferably arranged between the base body and the support surfaces and is aligned in such a way that its heating radiation direction points in the direction of the support surfaces. In this way, too, a homogenisation of the gob temperature can be brought about in an advantageous manner according to the invention.

Since a glass preform is usually introduced into an infrared heating furnace from below, in this way at the same time an irradiation and thus heating of the gob from below can occur. An IR radiation reflector also acts in a similar or similarly supporting manner if this IR radiation reflector corresponding to an infrared heating furnace is arranged such that heat radiation is emitted into the lower opening of the infrared heating furnace. In this case, an infrared radiation reflector can be used together with an infrared heating furnace. Alternatively, according to the invention, it is also possible for the device according to the invention to provide only an infrared radiation reflector or only an infrared heating furnace. In this context, it should also be noted that instead of an infrared heating furnace, an induction furnace or another suitable heating device can also be used.

According to another, the support elements comprise at least one device for stabilising the support elements at least between the base body and the reflector, or in particular between an upper lance part arranged above the base body and the reflector. The device for stabilising the support elements can, for example, be in the form of struts between the support elements and/or one or more perforated plate(s) through which the support elements extend, or in the form of a perforated block or, if necessary, several perforated blocks through which the support elements extend.

The support elements are attached to the upper lance part, which in turn is detachably attached, for example by means of a clamping ring, to a lower lance part, which in turn is associated with the base body and is arranged on the base body such that the upper lance part can be placed on the lower lance part and centred.

The device for stabilising the support elements primarily serves to fix the support elements with regard to their position relative to each other, so that it is prevented that the support elements warp or bend when they also heat up in the course of heating the gob.

To this end, the support elements are braced, connected, reinforced or constrained by way of the device for their stabilisation such that the support elements maintain their original desired position, shape and orientation. This is achieved, for example, by either bracing the support elements with each other, for example with rods, and stabilising them in this way. Another possibility to stabilise the support elements is to guide the support elements through one or more perforated plates, whereby the support elements are preferably firmly connected, in particular welded, to the one or more perforated plates, so that a relative movement between the support elements is prevented and the support elements hold or support each other and thus stabilise each other. If several perforated plates are used, they can be arranged spaced apart from each other between the upper lance part and the reflector. A further possibility for stabilising the support elements is to use thick perforated plates or alternatively a block, in particular solid, block, through which the support elements extend. In this case, too, the individual support elements can be firmly connected to the block, in particular welded. In this context, it should further be noted that the threaded bolts may extend either through the block and/or the at least one perforated plate. Alternatively, the block and the at least one perforated plate can also be formed, for example, in a star shape, such that the support elements are stabilised but the threaded bolts move outside the block and the at least one perforated plate. Furthermore, it should be noted in this context that several blocks can also be used, which are either arranged vertically one above the other or, for example, are also assigned to different support elements. Thus, according to the invention, it is conceivable, for example, that one block is assigned to each respective support element, which in turn prevents a support element from twisting or bending to the side. In this case, one support element at a time is stabilised without the individual support elements being quasi connected to each other.

According to a further advantageous embodiment of the invention, the support elements are part of a vertical press, wherein the support elements preferably extend through openings and/or guides provided in a lower part of the vertical press and are retractable into the lower part of the vertical press during a pressing operation, in particular a blank pressing operation. In this way, according to the invention, it is possible to move respective glass preforms or (glass) gobs resting on the, usually at least two, support elements, or supported by the support elements, along a vertical axis of the press, into a furnace and out of a furnace. After heating the glass preform(s) or (glass) gob(s) in the furnace, the preform(s) is/are conveyed out of the furnace again along the vertical axis of the press, namely either downwards or upwards, and subsequently pressed, in particular blank pressed.

Alternatively to a movement of the preform(s) into the furnace or out of the furnace, it is also possible according to the invention to position the preform(s) stationary along the vertical axis of the press and to move the, preferably tubular, furnace along the vertical axis of the press such that it surrounds the preform(s) such that the preform(s) can be heated.

A substantially simultaneous movement of the preform(s) and the furnace is also possible according to the invention, whereby by such a simultaneous movement in opposite directions of the preform and the furnace a particularly high cycle rate can be achieved.

According to a further embodiment of the invention, the furnace can also be designed to be foldable or divisible, in particular foldable about a vertical axis or divisible with respect to a vertical plane, so that one or more preform(s) can be enclosed by the furnace for heating and released from the furnace again after heating for pressing. The term “vertical” here always refers to the vertical axis of the press.

According to a further embodiment of the invention, it is also possible to move the glass preforms into the furnace and to press them in the same furnace, in particular to blank press them, without it being necessary to first remove the heated glass preforms from the furnace again and only then feed these glass preforms to a press. According to this variant, the furnace temperature can be selected such that the glass preforms are first heated at a higher furnace temperature and then the pressing process takes place at a lower furnace temperature.

At this point, it should be mentioned in particular that, if desired, such or possibly other desired temperature control of the furnace is also possible according to the invention for all other, in particular the above-mentioned, embodiments.

According to one embodiment of the invention, the preformed glass preforms or gobs are thus first placed on the support surfaces of the support elements, which extend through a lower press element of a vertical press, and then moved from below into a, generally cylindrical, furnace. According to the invention, the gobs are heated in the furnace at least superficially to such an extent that subsequent pressing, in particular blank pressing, of the heated glass preforms or gobs is possible. According to the invention, the pressing process is initiated by bringing the support surfaces of the support elements closer to a pressing surface of the lower pressing element until the support surfaces of the support elements are either flush with the pressing surface of the lower pressing element or, as desired, protrude slightly from the plane of the pressing surface or are retracted slightly below the plane of the pressing surface into the lower pressing element. The latter two possibilities can be used, for example, for profiling the underside of the gob, or possibly also for fixing of the gob, especially during the pressing process.

The approach of the support surfaces of the support elements to the pressing surface of the lower pressing element can be effected by retracting the support elements, which project upwards from the lower pressing element of the vertical press, into the lower pressing element. Alternatively, according to the invention, it is also possible that when the lower pressing element is stationary, the support elements projecting from it do not move, but conversely the support elements remain in a substantially stationary position, while the lower pressing element of the vertical press is raised along the support elements to such an extent that pressing according to the above explanations becomes possible. In this context, it should also be noted that the relative movement of the support surfaces of the support elements in relation to the pressing surface of the lower pressing element can also be effected such that on the one hand the support elements retract downwards into the lower pressing element, while the lower pressing element is simultaneously moved upwards in the direction of the support surfaces of the support elements until a desired end point is reached.

After the pressing process has been completed, the finished pressed glass article is removed from the pressing mould, whereby the support elements can be used for demoulding the glass article by pushing the finished glass article out of the pressing mould by an upward movement after cooling, or when the glass article is dimensionally stable with respect to a mechanical engagement of the glass article.

The pressing of the glass preforms in the vertical axis of the press, for example directly in, below or above the furnace in which the glass preforms are heated on the surface, made possible by the device according to the invention, offers numerous advantages, which consist on the one hand in the fact that an undesired cooling of the glass preforms can be avoided by means of the device according to the invention. On the other hand, there is thus also no danger of the glass preforms slipping or for example falling down during a lateral transfer of the preforms from the furnace to a press arranged sideways of the furnace. Furthermore, due to the direct pressing of the glass preform(s) directly in, below or above the furnace, a higher cycle frequency can also be run during the manufacture of the desired glass articles, since an unnecessary expenditure of time resulting from the previously necessary transfer of the heated glass preforms from the furnace to a press laterally removed from the furnace can be avoided according to the invention.

With regard to the invention described above, it should also be pointed out that the term glass preforms includes glass preforms of all types, but in particular gobs with a preferred thickness in the range of >5 mm, preferably >8 millimetres and particularly preferably >10 millimetres, as well as glass wafers, the latter, possibly profiled, flat glass objects having thicknesses in the range of <1 mm and, depending on the application, also thicker.

Further embodiments of the invention will be apparent from the dependent claims.

In the following, the invention is described by means of an embodiment example, which is explained in more detail with reference to the figures.

Herein show:

FIG. 1 a schematic representation of an embodiment of the device according to the invention in perspective side view;

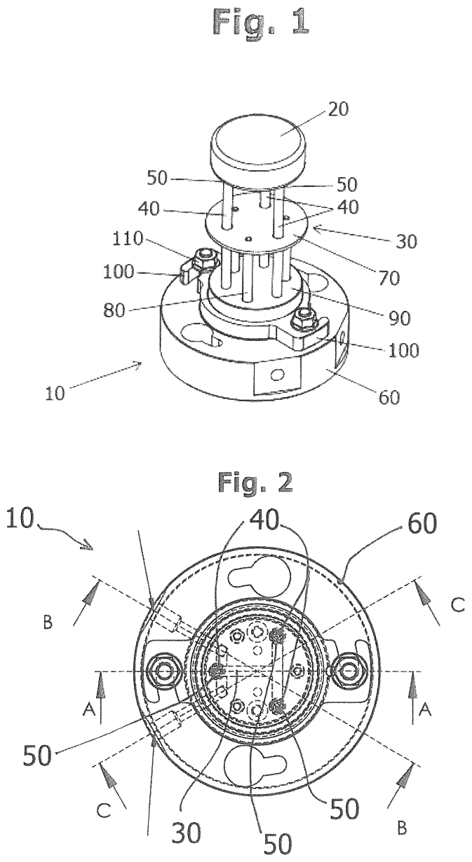

FIG. 2 a schematic representation of the embodiment according to FIG. 1 in top view;

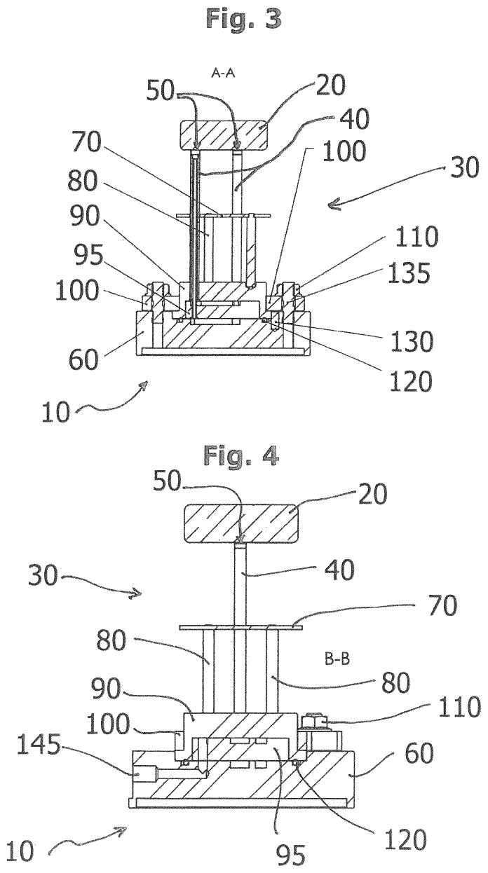

FIG. 3 a schematic side sectional view of the embodiment according to FIG. 2 along sectional line A-A;

FIG. 4 a schematic side sectional view of the embodiment according to FIG. 2 along the sectional line B-B; and

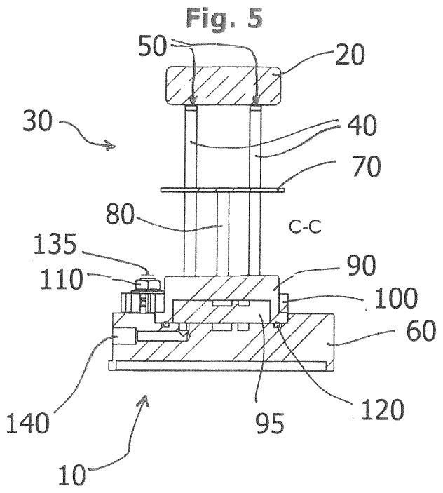

FIG. 5 a schematic side sectional view of the embodiment according to FIG. 2 along sectional line C-C.

In the following description, the same reference numbers are used for the same and similarly acting parts.

FIG. 1 shows a schematic representation of an embodiment of the device 10 according to the invention for supportingly holding a glass preform 20 in a perspective side view from obliquely above. The device 10 comprises a carrier device 30 formed by three support elements 40. The individual support elements 40 each have a support surface 50 on which the glass preform or gob 20 rests evenly. The support elements 40 are attached to an upper lance part 90, which is detachably fastened to a lower lance part 95 by means of a clamping ring 100. For fastening the upper lance part 90 to the lower lance part 95, or for securing the clamping ring 100, nuts 110 are provided in each case, with which the upper lance part 90 can be fastened to the lower lance part 95 in the manner of a quick-release fastener. In this context an O-ring 120 acts as bearing for the upper lance part 90. The lower lance part 95 is associated with a base body 60 and arranged on the base body 60 such that the upper lance part 90 can be placed on the lower lance part 95 and centred by means of the lower lance part 95. Furthermore, the base body 60 has at least a first screw 130 and a second screw 135, which serve as fastening means for the upper lance part 90, or the clamping ring 100, and represent the fastening counterpart to the nuts 110. Furthermore, the device 10 according to the invention comprises a reflector 70 through which the support elements 40 extend and which is arranged such that it is located between the upper lance part 90 and the glass preform 20. The reflector 70 is in turn adjustable in height by means of threaded bolts 80 and can thus be moved closer to or away from the glass preform 20 as desired. In particular, the detailed construction of the device according to the invention can be seen particularly well from FIG. 2 to FIG. 5, which show the device according to the invention in each case in a top view or in three different sectional views. It can also be seen clearly from FIG. 4 and FIG. 5 that the base body 60 has a cooling air flow 140 and a cooling air return 145, with which the device according to the invention and in particular the support elements 40 can be tempered and in particular cooled as desired, whereby a fluid, such as air, can be used for cooling. The fluid can be tempered in advance to a desired temperature.

At this point, it should be noted that all of the parts described above, taken individually and in any combination, in particular the details shown in the drawings, are claimed as being essential to the invention. Modifications thereof are familiar to the person skilled in the art.

### LIST OF REFERENCE SIGNS

10 device
20 preform
30 carrier device
40 support element
50 support surface
60 base body
70 reflector
80 threaded bolt
90 upper lance part
95 lower lance part
100 clamping ring
110 nut
120 O-ring
130 first screw
135 second screw
140 cooling air flow
145 cooling air return

1. A device for supportingly holding and moving a glass preform, the device comprising:
a carrier device;
at least one rod-shaped support element which is oriented substantially vertically aligned during operation, the at least one rod-shaped support element terminating at its upper end in at least one point-shaped upwardly directed support surface; and
at least one substantially vertically oriented and substantially inverted U-shaped support element having an upwardly directed support surface connecting the substantially vertically extending vertical portions of the support element.

2. The device according to claim 1,
wherein
the at least one rod-shaped support element has at its upper end at least two extensions which each open into a point-shaped upwardly directed support surface.

3. The device according to claim 2,
wherein
the at least one rod-shaped support element is substantially Y-shaped or is formed with an inverted tripod, wherein each of the extensions opens in a respective point-shaped upwardly directed support surface.

4. The device according to claim 1,
wherein
the device comprises at least two rod-shaped support elements or at least one substantially inverted-U-shaped support element, the respective support surfaces of the support elements arranged in a common plane.

5. The device according to claim 1,
wherein
the support surfaces are each arranged at vertices or sides of a triangle, or, in the case of more than three support elements, of a polygon.

6. The device according to claim 1,
wherein
the support surfaces of the rod-shaped support elements have a symmetrical, round or ring-shaped, cross-section in top view.

7. The device according to claim 1,
wherein
the support surfaces are substantially flat or convexly curved, in sections, in particular pointing upwards.

8. The device according to claim 1,
wherein
the point-shaped support surfaces each have an area in the range from 1 mm² to 100 mm².

9. The device according to claim 1,
wherein
the support surfaces are made of or coated with a high temperature-stable material, steel, gold, copper, ruthenium, osmium, zirconium, hafnium, niobium, tantalum, chromium, molybdenum or tungsten or a refractory alloy or a ceramic, a carbide or nitride, or are inert to glass at temperatures in the range of 700° C. to 1500° C.

10. The device according to claim 1,
wherein
the support elements or the support surfaces comprise at least one common cavity or at least one common channel or conduit, wherein the respective cavity or the respective channel or conduit is able to be flowed-through with a gaseous fluid.

11. The device according to claim 1,
wherein
the support elements are detachably attachable to a base body individually or jointly by means of a quick-change fastener.

12. The device according to claim 11,
wherein
the device has at least one reflector, which is arranged between the base body and the support surfaces and is aligned such that its reflection surface points in the direction of the support surfaces.

13. The device according to claim 11,
wherein
the device has at least one induction or IR heater, which is arranged between the base body and the support surfaces (50) and is aligned such that its heating radiation direction points in the direction of the support surfaces (50).

14. The device according to claim 1,
wherein
the support elements are each jointly or individually adjustable in height between the base body and the reflector between an upper lance part arranged above the base body and the reflector, and comprise at least one device for stabilising the support elements in the form of struts between the support elements or one or more perforated plate(s) through which the support elements extend or a perforated block through which the support elements extend.

15. The device according to claim 1,
wherein
the support elements are part of a vertical press, wherein the support elements extend through openings or guides provided in a lower part of the vertical press and are retractable into the lower part of the vertical press during a blank pressing operation.
